(19) United States
(12) Patent Application Publication
(10) Pub. No.: US 2013/0263674 A1
(43) Pub. Date: Oct. 10, 2013

(54) TUBE OR PIPE CLAMP WITH A FORCE MEASUREMENT DEVICE

(71) Applicants: Kevin McKiernan, Hillsborough, NJ (US); Ted M. Hinds, East Stroudsburg, PA (US); Daniel J. Mathien, Amherst, NY (US)

(72) Inventors: Kevin McKiernan, Hillsborough, NJ (US); Ted M. Hinds, East Stroudsburg, PA (US); Daniel J. Mathien, Amherst, NY (US)

(73) Assignee: ENGINEERED PRODUCT SUPPLY, LLC, d/b/a/ EPS, Branchville, NJ (US)

(21) Appl. No.: 13/440,298

(22) Filed: Apr. 5, 2012

(51) Int. Cl. G01N 3/02

(52) U.S. Cl. 73/856

(57) ABSTRACT

A tube or pipe clamp incorporates a clamping force measurement device. A support body is disposable around a threaded bolt of a locking assembly of the tube or pipe clamp. At least one spring element is held by the support body, a compression member being disposed in operative contact with the spring element for compressing the same in a clamp tightening operation. A scale is provided on one of the support body and the compression member for indicating a degree of compression of the spring element and concomitantly a magnitude of compressive force exerted by the compression member and the bolt on the tube or pipe clamp.

### BACKGROUND OF THE INVENTION

This invention relates to tube or pipe clamps. More particularly, this invention relates to a device to be used with tube or pipe clamps or to be incorporated into such clamps for facilitating effective usage thereof.

Flanged ferrule tube connections are used extensively in industry. The type of joint shown is a common clamped flange design. The ferrules have angled (conical) surfaces. The clamp captures the ferrules and contacts them on the conical faces. By clamping the clamp diametrically, the contact on the angled surfaces causes a linear force component to squeeze the ferrules together in a direction that squeezes the gasket between them.

Industry has had various challenges with this type of clamp, including:
1. Extrusion of the gasket into the liquid flow area of the tubes.
2. Difficulty determining the correct tightening torque to be applied at the wing nut.
3. Inability to give standard tightening instructions for various ferrule and clamp sizes.
4. Leaking joints due to heating and cooling of system fluid and clamped tubes.
5. Loosening of wing nuts, causing them to sometimes swing open.

Participants in the industry and industry standards-creating bodies have attempted to solve this problem by introduction of standard component configurations and new products. Products include metal-to-metal ferrules with fixed gasket space, various durometer gaskets, hard gaskets, gasket appendages to achieve fixed ferrule-to-ferrule distance, torque-limiting nuts and live load nuts.

The current state of the art includes spring clamping devices, which are meant to give some control or indication of clamping force. They are based on the expectation that the pull force on the clamping bolt is related to clamping force at the gasket. Two devices known to apply this theory are described in U.S. Pat. No. 5,653,481 to Alderman and U.S. Pat. No. 6,082,941 to DuPont.

The Alderman patent is directed to a so-called live loading nut. Possible improvements over Alderman might include 1) a simplified design which eliminates second guide diameters on two components, 2) elimination of the need for a torque wrench for installation, and 3) reduction or elimination of friction and other forces within the prior art device itself and in the torque wrench.

U.S. Pat. No. 6,082,941 discloses a device for tube clamps for the purpose of allowing an installer to tighten each nut to a specified torque matched to gasket material. Potential improvements over this prior art might include 1) simplified design, 2) reduction or elimination of friction and other forces within the prior art device itself, and 3) elimination of the need for a wrench or other tool for tightening.

### OBJECTS OF THE INVENTION

It is an object of the present invention to provide an improved tube or pipe clamp.

A related object is to provide a tube or pipe clamp incorporating a device for alleviating at least some of the above-described problems with tube clamps.

Another object of the present invention is to provide a device as part of a tube clamp to facilitate control and monitoring of clamping force on an inter-pipe gasket.

A further object of the present invention is to provide such a device that is easy to install and easy to use.

These and other objects of the present invention will be apparent from the descriptions and drawings herein. Although every object of the invention is attainable by at least one embodiment of the invention, there is not necessarily any single embodiment that achieves all of the objects of the invention.

### SUMMARY OF THE INVENTION

A tube or pipe clamp in accordance with the present invention comprises two clamp members, a locking device, and a clamp force measurement device. The clamp members are pivotably connected to one another at respective hinge-forming ends thereof. The locking device includes a shaft and a locking element operatively attached to the shaft, the shaft being pivotably attached to one of the clamp members, the other of the clamp members having a pair of prongs defining a slot for receiving the shaft so that the locking element is engageable with the prongs to lock the clamp members to one another at ends thereof opposite the hinge-forming ends. The clamping force measurement device includes a support body, at least one spring element, a compression member, and a scale or metric indication. The support body is disposable around the shaft of the locking device. The one or more spring elements are held by the support body. The compression member is in operative contact with the spring element for compressing same in a clamp tightening operation. The scale is disposed on the support body or the compression member for indicating a degree of compression of the spring element and concomitantly a magnitude of compressive force exerted by the compression member and the bolt on the tube or pipe clamp.

Concomitantly, a clamping force measurement device comprises, in accordance with the present invention, a support body disposable around a threaded bolt of a locking assembly of a tube clamp, at least one spring element held by the support body, a compression member in operative contact with the spring element for compressing the same in a clamp tightening operation, and a scale on one of the support body and the compression member for indicating a degree of compression of the spring element and concomitantly a magnitude of compressive force exerted by the compression member and the bolt on the tube clamp.

The support body of the clamping force measurement device may take the form of a housing, casing, or enclosure. The one or more spring elements are then disposed in the housing. The spring elements may take the form of one or more helical springs or a plurality of spring washers arrayed in a stack.

Pursuant to another feature of the present invention, the support body or housing of the clamping force measurement device has a set of walls, at least one of which is formed with a window. The scale is disposed on a surface of the housing proximate the window.

An indicator element, which may be a feature of the compression element of the clamping force measurement device, such as an edge of the compression element or a marking disposed on a lateral surface thereof, is disposed in the housing and is visible through the window. The indicator element may be a separate member. In any event, the indicator element is movable relative to the scale to conform to the degree of compression of the spring element(s) and therefore to the amount of force exerted by the tube or pipe clamp.

The compression member of the clamp force measurement device may take the form of a spacer slidably disposed inside the housing and disposed in contact with the locking element of the tube or pipe clamp, which may take the particular form of a tightening nut that is threadably connected to the shaft, e.g., bolt, of the locking device. Typically the tightening nut is a wing nut. The compression spacer may have a cylindrical form provided along one surface with a concavity that receives or seats the tightening nut. The indicator may be an edge of the spacer or a line printed on a lateral surface thereof.

In an alternative embodiment of the invention, the compression member may be the locking element of the clamp's locking device. Where the locking element is a wing nut and the shaft of the locking device is a bolt threadably connected the wing nut, the portion of the compression member in contact with the at least one spring element may be a shaft of the wing nut.

A clamping force measurement device in a tube or pipe clamp in accordance with the present invention compensates or accounts for variation in gasket durometer. It also facilitates the application of proper amounts of torque, regardless of clamp size. Where installed ferrules are misaligned or improperly distanced from one another, a clamping force measurement device as described herein helps determine that this is the case.

The present invention improves the accuracy of measurement of the clamping force on a gasket, relative to all conventional devices. Use of the present invention can correct some root causes of leaking joints due to heating and cooling of a conduit system.

The present invention can prevent or reduce the occurrences of clamps swinging open with temp changes and wing nuts becoming loose.

When a pipe or tube clamp having a clamping force measurement device in accordance with the present invention is used properly and ferrules are properly set and aligned, the present invention can serve to reduce, if not eliminate, extrusion of gasket into the flow area.

### BRIEF DESCRIPTION OF THE DRAWINGS

FIG. 1 is a perspective view of a tube clamp incorporating a clamping force measurement device, in accordance with the present invention.

FIG. 2 is a perspective view, partially broken away, of the tube clamp and clamping force measurement device of claim 1.

FIG. 3 is a side elevational view of the tube clamp of FIGS. 1 and 2, showing the clamping force measurement device of FIGS. 1 and 2 in cross-section.

FIG. 4 is a side elevational view, on a larger scale, of the clamping force measurement device of FIGS. 1-3.

FIG. 5 is an exploded perspective view, on an intermediate scale, of the clamping force measurement device of FIGS. 1-4.

### DETAILED DESCRIPTION

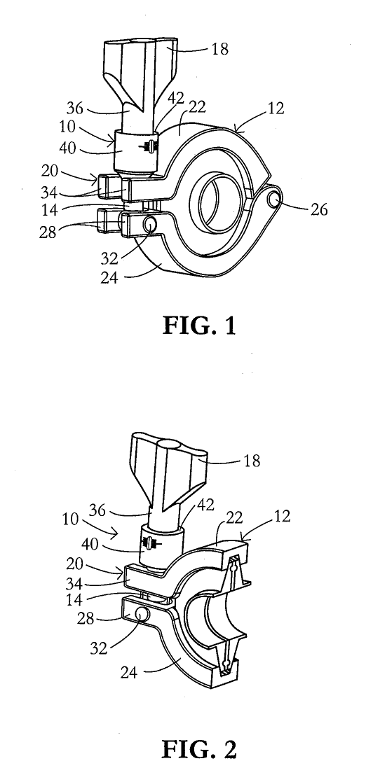

As depicted in FIGS. 1-3, a clamping force measurement device 10 in a tube clamp 12 is disposed around a shaft or bolt 14 of a clamp locking device 16 between a wing nut 18 for tightening or locking the locking device and a fork portion 20 of an upper clamp member 22. A lower clamp half or member 24 is pivotably connected to upper clamp member 22 at a hinge 26.

Bolt 14 of clamp locking device 16 is pivotably attached to lower clamp member 24. Specifically, bolt 14 is pivotably connected to a pair of flanges or prongs 28 of lower clamp member 24. More specifically, an eyelet-bearing base portion 30 of bolt 14 receives a pivot pin 32 that extends between flanges or prongs 28.

In the closed and locked configuration of clamp 10 depicted in FIGS. 1-3, bolt 14 extends from lower clamp member 24 between two prongs 34 of fork portion 20 of upper clamp member 22. Wing nut 18 is screwed onto bolt 14 and a shaft portion 36 of wing nut 18 extends into and operatively engages clamping force measurement device 10.

Clamping force measurement device 10 includes a support body 38 in the form of a housing or casing having a cylindrical sidewall 40. On an upper side, an annular lip 42 extends inwardly from cylindrical sidewall 40 to define an opening 44. Opening 44 is traversed by wing nut shaft portion 36 in the installed configuration of the clamping force measurement device.

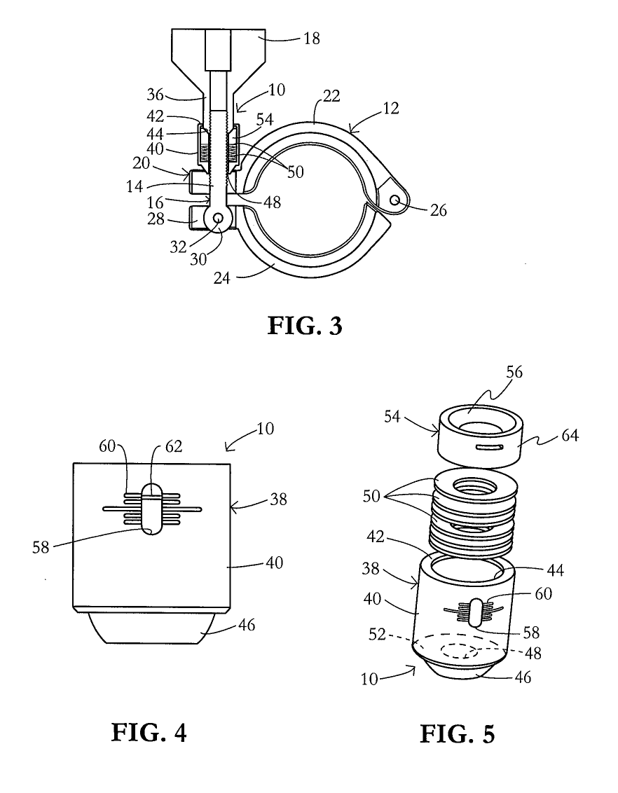

Support body or housing 38 further includes a nipple or extension 46 at an end opposite lip 42 and opening 44. Nipple or extension 46 is insertable between prongs 34 of fork portion 20 and is provided at a free end with an aperture 48 (FIG. 3) which is traversed by bolt 14.

Clamping force measurement device 10 further includes a plurality of spring washers or disk springs 50 which are disposed inside support body 38 around bolt 14 of locking device 16. Disk springs 50 are held in contact with one another, in a compressed array, between (a) an annular shoulder or ledge 52 extending inwardly at a lower end of cylindrical sidewall 40 and (b) an annular compression member 54 in the form of a spacer slidably disposed inside housing 38 at an upper end thereof.

Compression member or spacer 54 in turn is disposed in contact with shaft portion 36 of wing nut 18. Compression member 54 has an annular or cylindrical form provided along an upper surface with a concavity or recess 56 that receives or seats a free end of wing nut shaft portion 36.

As shown in FIGS. 4 and 5, sidewall 40 of clamping force measurement device 10 is provided with a window 58 and a force indication scale 60 in juxtaposition to the window. A force magnitude indicator 62 (FIG. 5) line printed, painted, cut, burned, molded or engraved on a lateral surface 64 of compression member 54. Alternatively, the force magnitude indicator may be an edge (not separately designated) of compression member 54.

In using the clamp force measurement device 10 with clamp 12, one slips support body 38 together with spring disks 50 about bolt 14. Bolt 14 may have been already pivoted into its locking position, where it extends between prongs 34 of upper clamp member fork portion 20. Wing nut 18 is then twisted onto the free end of bolt 14 so that the free end of shaft portion 36 is seated in concavity or recess 56 of compression member 54. As wing nut 18 is turned, the clamp 10 is tightened about a pair of tubular conduit members (not shown) at a ferrule joint, about which the clamp is previously positioned. Compression member 54 compresses the array of spring disks 50 in direct proportion to the amount of force exerted on clamp 10 by locking device 26. The magnitude of applied force may be read by comparing the location of indicator 62 with the markings of scale 60.

Clamping force measurement device 10 allows the installer to set clamp 12 to a specific force at the clamping bolt 14, to see an indication of the force during installation, and to monitor the force visually without having to tighten wing nut 18 or use a torque wrench. The indication is done by direct indication of spring compression. The indication is almost entirely free of errors due to internal friction of the device or inaccuracies of an external torque wrench. The user tightens the wing nut 18 until indicating line 62 reaches a desired force-level line adjacent to window 58 on support body 38. By easy calculations and testing, a manufacturer can relate the degree of spring compression to an amount of gasket compression between the ferrules.

One limitation of clamping force measurement device 10 is the inability, in some installations, to distinguish whether the clamping force is just a result of compressing the gasket, or if ferrule misalignment or improper ferrule distance are also factors. This limitation exists for all known devices. However, the improvements provided by clamping force measurement device 10 exclude other error factors and may make detection of ferrule misalignment and ferrule misplacement easier. If one can always see accurately the clamping force being applied and know that only gasket compression and ferrule alignment are factors, it should be easier to troubleshoot any leakage or misalignment issues.

One important benefit of clamping force measurement device 10 relative to prior art devices is eliminating the torque-limiting and/or torque-measuring functions that add error and complexity. The force of interest to be measured and controlled is the direct linear force on bolt 14. By adding the torque aspect, the prior art devices add complexity, variables and errors, with not added benefit.

Another benefit of clamping force measurement device 10 relative to prior art devices is no torque wrench is required. Users in quality-controlled environments must maintain calibration systems for accurate torque wrenches if the torque wrenches affect system performance and safety.

A further benefit of clamping force measurement device 10 is that it can be used with the industry-standard wing nuts prevalent in industry. No wrench is needed. Yet another benefit is the clamp force can be monitored visually at any time. A further advantage is that clamping force measurement device 10 provides a live load that continues to exert clamping pressure even when the ferrules are pushed together by an external input, such as expansion of pipes and tubes due to heating of the system. The same feature; i.e., the ability of the clamp to continue applying force through the spring over some range of compression, also prevents the problem of wing nuts coming loose and swinging open.

Although the invention has been described in terms of particular embodiments and applications, one of ordinary skill in the art, in light of this teaching, can generate additional embodiments and modifications without departing from the spirit of or exceeding the scope of the claimed invention. For example, one or more helical spring members may replace disk springs 50. Also, the scale markings may be provided on shaft portion 36 of wing nut 18 or even on compression member or spacer 54, instead of on sidewall 40 of support body 38. Furthermore, compression member or spacer 54 may be eliminated altogether, with a free end of wing nut shaft portion 36 placed directly in engagement with an uppermost spring disk 50. In that case, wing nut 18 and particularly shaft portion 36 thereof performs the function of compression member 54.

Accordingly, it is to be understood that the drawings and descriptions herein are proffered by way of example to facilitate comprehension of the invention and should not be construed to limit the scope thereof.

What is claimed is:

1. A tube or pipe clamp comprising:
two clamp members pivotably connected to one another at respective hinge-forming ends thereof;
a locking device including a shaft and a locking element operatively attached to said shaft, said shaft being pivotably attached to one of said clamp members, the other of said clamp members having a pair of prongs defining a slot for receiving said shaft so that said locking element is engageable with said prongs to lock said clamp members to one another at ends thereof opposite said hinge-forming ends; and
a clamping force measurement device including:
a support body disposable around said shaft;
at least one spring element held by the support body; a compression member in operative contact with said spring element for compressing same in a clamp tightening operation; and
a scale on one of said support body and said compression member for indicating a degree of compression of said spring element and concomitantly a magnitude of compressive force exerted by said compression member and said bolt on the tube or pipe clamp.

2. The tube or pipe clamp of claim 1 wherein said support body is a housing, said at least one spring element being disposed in said housing.

3. The tube or pipe clamp of claim 2 wherein said housing is formed with a window, said scale being disposed on a surface of said housing proximate said window.

4. The tube or pipe clamp of claim 3 wherein said compression member is a spacer slidably disposed inside said housing and disposed in contact with said locking element.

5. The tube or pipe clamp of claim 4 wherein said spacer is formed with a concavity receiving said locking element.

6. The tube or pipe clamp of claim 4, further comprising an indicator movable relative to said support body and said scale in accordance with the degree of compression of said at least one spring element.

7. The tube or pipe clamp of claim 6 wherein said indicator is a feature of said spacer.

8. The tube or pipe clamp of claim 1 wherein said compression element is a spacer slidably mounted to said support body and disposed in contact with said locking element.

9. The tube or pipe clamp of claim 8 wherein said spacer is formed with a concavity receiving said locking element.

10. The tube or pipe clamp of claim 1 wherein said scale is disposed on a surface of said support body.

11. The tube or pipe clamp of claim 10, further comprising an indicator movable relative to said scale in accordance with the degree of compression of said at least one spring element.

12. The tube or pipe clamp of claim 11 wherein said indicator is a feature of said compression element.

13. The tube or pipe clamp of claim 1 wherein said compression member is a portion of said locking element.
